(19) United States
(12) Patent Application Publication
(10) Pub. No.: US 2022/0219400 A1
(43) Pub. Date: Jul. 14, 2022

(54) SYSTEM AND METHOD TO INCREASE ACCURACY OF AN IMAGING SYSTEM WITHIN AN ADDITIVE MANUFACTURING DEVICE

(71) Applicant: B9CREATIONS, LLC, Rapid City, SD (US)

(72) Inventor: Michael Joyce, Rapid City, SD (US)

(21) Appl. No.: 17/346,104

(22) Filed: Jun. 11, 2021

Related U.S. Application Data
(60) Provisional application No. 63/136,735, filed on Jan. 13, 2021.

(51) Int. Cl. B29C 64/393; G06T 7/80; G06T 7/00; B33Y 50/02; B33Y 30/00

(52) U.S. Cl. CPC B29C 64/393; G06T 7/80; B33Y 30/00; B33Y 50/02; G06T 7/0004

(57) ABSTRACT

A method is disclosed to calibrate factors to correct at least one hardware deviation in an image system of an additive manufacturing device where the method includes sampling output positions in a grid pattern created by the additive manufacturing device to establish at least one sample point based on loop vertices, measuring the grid pattern with a measurement and inspection system, producing a data file which contains positions of the sampled points with corrected locations as determined with the measurement and inspection system, applying the corrected locations to each respective profile loop vertices by adjusting coordinates of each loop vertex based on the correction factors and performing a validation print to verify that the additive manufacturing device is calibrated correctly based on the corrected locations. A system and a non-transitory processor readable storage medium residing on a mobile device, providing an executable computer program product are also disclosed.

### CROSS-REFERENCE TO RELATED APPLICATIONS

This application claims the benefit of U.S. Provisional Application No. 63/136,735 filed Jan. 13, 2021, the entirety of which is incorporated by reference.

### BACKGROUND

Embodiments generally relate to additive manufacturing devices and more particularly to systems, methods, and computer program products for enhancing (reducing) the production workflow throughput as well as increasing the output product's accuracy and surface finish.

Pixel based additive manufacturing devices produce three-dimensional objects by sequentially adding materials in a layered pattern. This mask pattern represents the cross-sectional area for the layer. Devices such as DLP projectors and LCD masks create a pattern by activating desired “pixels” to selectively allow the activating energy to solidify the desired cross-sectional areas.

Traditionally, three-dimensional objects are represented as a “mesh” of polygons. Prior to the actual additive manufacturing process, this data is typically evaluated by software on a computing device which is separate from the additive manufacturing device. This evaluation produces an output in a format suitable for additive manufacturing devices using pixel formats. As such, the typical output includes which pixels are activated as well as the activation level per pixel. This activation level is driven by the additive manufacturing hardware, including the imaging device, and is typically limited in resolution to a value that can be represented by eight bits (0-255). Often, the output resolution is much less, as the evaluation process is very computationally intensive and the desire to accomplish it quickly is traded against the desire to increase the activation resolution. The resulting output is considered a collection of raster images where the collection of raster image includes a plurality of cross section images of the object, meaning a raster image for every layer, to be additively manufactured.

There are disadvantages to the current methods. The time required to pre-process the additive manufacturing device output can be extensive, ranging from several minutes to hours as imaging is usually accomplished by creating a raster image of a component to be made with the additive manufacturing device is usually utilized. The output has a limited activation resolution, determined during the evaluation. Due to the limited activation resolution, the ability for the additive manufacturing device to adjust the output for factors such as individual device calibration errors and specific material adjustment factors is limited, leading to limited output accuracy. Further, such adjustments typically lead to undesired artifacts in the output products which reduce the surface finish quality of the output product.

Imaging accuracy is also important in an additive manufacturing device as an accurate image provides for a correct additive manufactured object being printed. Otherwise, if accuracy of the image is not obtained, the additive manufactured object may include physical errors. Such physical errors may be visibly seen or may be internal to the object. Even though possibly not visible, the physical error may affect the structural soundness of the object. More specifically, though a surface the object may appear to be correct as its appearance appears correct, the internal structure may not have the desired support as structural material may have been omitted from an area during the manufacturing process where the material is needed for structural support. Representative examples of projected optical image errors include, but are not limited to, a scaling error, keystone error, barreling error, pincushion error and other aberrations. These sorts of optical errors are usually a result of imperfect optics in the imaging device which are not solely the result of the optical lenses used.

Given the foregoing, manufacturers, users and owners of additive manufacturing devices need additive manufacturing devices which facilitate a timely evaluation of the three-dimensional object while also overcoming the issues of reduced accuracy and limited surface finish of current systems and methods. Also needed is an ability to have any errors corrected prior to printing of an object occurs. As a non-limiting example, manufacturers, users and owners would benefit from having correction of the imaging system, or projector, of the additive manufacturing device identified and corrected at least one of at a time the additive manufacturing device is manufactured and when a part of the additive manufacturing device is replaced.

### SUMMARY

This Summary is provided to introduce a selection of concepts. These concepts are further described below in the Detailed Description section. This Summary is not intended to identify key features or essential features of this disclosure's subject matter, nor is this Summary intended as an aid in determining the scope of the disclosed subject matter. Embodiments to a system and method to correct imaging inaccuracies caused by an imaging system of the additive manufacturing device are disclosed.

The method is provided to calibrate factors to correct at least one hardware deviation in an image system of an additive manufacturing device. The method comprises sampling output positions in a grid pattern created by the additive manufacturing device to establish at least one sample point based on loop vertices. The method further comprises measuring the grid pattern with a measurement and inspection system. The method also comprises producing a data file which contains positions of the sampled points with corrected locations as determined with the measurement and inspection system. The method further comprises applying the corrected locations to each respective profile loop vertices by adjusting coordinates of each loop vertex based on the correction factors. The method also comprises performing a validation print to verify that the additive manufacturing device is calibrated correctly based on the corrected locations.

A non-transitory processor readable storage medium residing on a mobile device, providing an executable computer program product, the executable computer program product comprising a computer software code is also provided. The processor is caused to sample output positions in a grid pattern created by the additive manufacturing device to establish at least one sample point based on loop vertices. The processor is further caused to measure the grid pattern with a measurement and inspection system. The processor is also caused to produce a data file which contains positions of the sampled points with corrected locations as determined with the measurement and inspection system. The processor is further caused to apply the corrected locations to each respective profile loop vertices by adjusting coordinates of each loop vertex based on the correction factors. The processor further is caused to perform a validation print to verify that the additive manufacturing device is calibrated correctly.

The system comprises a processor utilizing a non-transitory processor readable storage medium to sample output positions in a grid pattern created by the additive manufacturing device to establish at least one sample point based on loop vertices. The system further comprises the processor utilizing the non-transitory processor readable storage medium to measure the grid pattern with a measurement and inspection system. The system also comprises the processor utilizing the non-transitory processor readable storage medium to produce a data file which contains positions of the sampled points with corrected locations as determined with the measurement and inspection system. The system further comprises the processor utilizing the non-transitory processor readable storage medium to apply the corrected locations to each respective profile loop vertices by adjusting coordinates of each loop vertex based on the correction factors. The system also comprises an additive manufacturing device to create a validation print. The system further comprises the processor utilizing the non-transitory processor readable storage medium to verify that the additive manufacturing device is calibrated correctly based on the validation print.

### BRIEF DESCRIPTION OF THE DRAWINGS

A more particular description briefly stated above will be rendered by reference to specific embodiments thereof that are illustrated in the appended drawings. Understanding that these drawings depict only typical embodiments and are not therefore to be considered to be limiting of its scope, the embodiments will be described and explained with additional specificity and detail through the use of the accompanying drawings in which:

FIG. 1 is an image of a graphical representation of a three-dimensional object mesh (only a portion of the mesh is drawn) bisected by the intersection of a plane, planar with the XY plane) at a certain Z elevation to be generated by an additive manufacturing process, according to an aspect of the present disclosure;

FIG. 2 is an image of a graphical representation of the intersection of the plane from FIG.1 with the three-dimensional object mesh, where the intersection is represented by line segments forming loops, according to an aspect of the present disclosure;

FIG. 3 is an image of a typical additive manufacturing device with built in graphical user interface, memory and internal computational hardware;

FIG. 4 shows an embodiment of a grid pattern for sampling position errors;

FIG. 5 shows a representation of correction factors being applied to original data;

FIG. 6 shows a close-up view of part of a loop edge on a grid;

FIG. 7 shows an image where errors due to unwanted profile self-intersections occurred;

FIG. 8 shows an image where the set of profile loops are arranged to ensure self-intersection does not occur;

FIG. 9 shows an embodiment of a flow chart illustrating a method to apply calibration factors determined during an additive manufacturing process to correct for hardware deviations;

FIG. 10 is an embodiment of a flowchart illustrating use of the loops;

FIG. 11 shows an embodiment of a process using individual loops versus a prior art approach where a plurality of loops is processed at a same time; and

FIG. 12 is an embodiment of a block diagram of an exemplary computer system.

### DETAILED DESCRIPTION

Embodiments are described herein with reference to the attached figures wherein like reference numerals are used throughout the figures to designate similar or equivalent elements. The figures are not drawn to scale and they are provided merely to illustrate aspects disclosed herein. Several disclosed aspects are described below with reference to non-limiting example applications for illustration. It should be understood that numerous specific details, relationships, and methods are set forth to provide a full understanding of the embodiments disclosed herein. One having ordinary skill in the relevant art, however, will readily recognize that the disclosed embodiments can be practiced without one or more of the specific details or with other methods. In other instances, well-known structures or operations are not shown in detail to avoid obscuring aspects disclosed herein. The embodiments are not limited by the illustrated ordering of acts or events, as some acts may occur in different orders and/or concurrently with other acts or events. Furthermore, not all illustrated acts or events are required to implement a methodology in accordance with the embodiments.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements. Furthermore, unless otherwise clear from the context, a numerical value presented herein has an implied precision given by the least significant digit. Thus, a value 1.1 implies a value from 1.05 to 1.15. The term “about” is used to indicate a broader range centered on the given value, and unless otherwise clear from the context implies a broader range around the least significant digit, such as “about 1.1” implies a range from 1.0 to 1.2. If the least significant digit is unclear, then the term “about” implies a factor of two, e.g., “about X” implies a value in the range from 0.5X to 2X, for example, about 100 implies a value in a range from 50 to 200. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 4.

Embodiments are directed to systems, methods, and computer program products wherein a three-dimensional object represented by a “mesh” of points in three-dimensional space, such as maintained in an “.stl” file format in a computer storage device and is readable by a computer processor, is evaluated in such a way as to rapidly produce an output of “loop” data which may be transferred to an additive manufacturing device, as a non-limiting example, for use in creating a three dimensional object. Such a device utilizing the loop data, correcting for device calibration errors, material factors, solidification energy intensity variations, to produce a three-dimensional object in less time and with better precision, accuracy and surface finish than current processes when compared to using a raster image, for example.

The term “additive manufacturing process” and/or the plural form of this term are used throughout herein to refer to any procedure wherein material is sequentially added in a pattern in order to form an object, such as 3D printing and the like.

The term “additive manufacturing device” and/or the plural form of this term are used throughout herein to refer to any apparatus capable of performing all or a portion of an additive manufacturing process, such as 3D printers and the like.

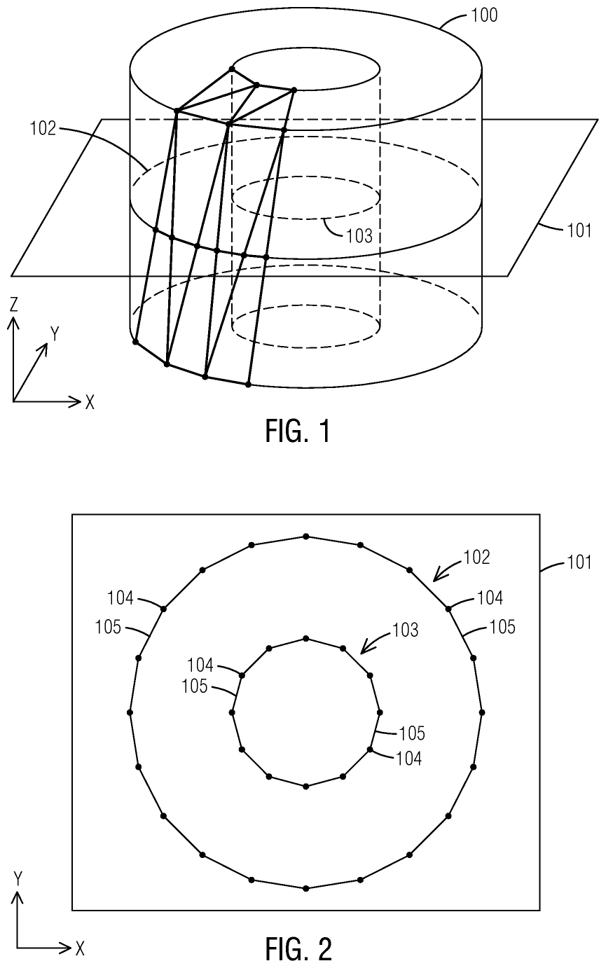

Referring now to FIG. 1, an image of a graphical representation of a three-dimensional object 100 to be generated by an additive manufacturing process, according to an aspect of the present disclosure, is shown. As will be appreciated by those skilled in the relevant art, sometimes the three-dimensional object 100 to be created may be represented by sets of vertices positioned along the surface of the object. These sets define surface segments which, when taken together, define the physical shape of the object. The number and size of these surfaces often define the precision of the definition. FIG. 1 illustrates just a few of these vertex points with line connections to clarify the above explanation.

XY Plane 101 is a plane, created planar to the XY axis plane at a desired Z elevation and is referred to as the “slice plane.” Often during the processing of the object 100 multiple slice planes are created at intervals, in the low micron level, that cover the Z elevation range of the object 100. Often, some portion of this set of slice planes is used by the additive manufacturing process to create the physical object 100.

A solid loop 102 and a void loop 103 may be formed by the intersection of XY Plane 101 with the object 100 mesh data. As will be appreciated by those skilled in the relevant art, for a given slice plane and object, that the number of solid and void loops may vary from zero to very large depending on the complexity of the object and the Z elevation of the slice plane. But as a general rule, for a well-defined object 100, there will be no intersections between any loops.

Referring now to FIG. 2, the slice plane 101 may be provided in a two-dimensional aspect. The intersection between the object 100 and the XY Plane 101 has created two dimensional vertices 104 which are connected to adjoining vertices by line segments 105 and taken together form either void or solid loops. In one aspect, when a list of vertices is sorted such that traversing them moves around the loop in a clockwise manner that loop is considered a void loop. When traversing them moves around the loop in a counter-clockwise manner that loop is considered a solid loop. If the average of the angles measured at each vertex in a closed loop totals less than 180 degrees, a solid loop is realized. Likewise, if the average of the angle measured at each vertex in a closed loop totals more than 180 degrees, a void loop is realized.

Utilizing modern computing hardware and software all the slice plane loop data for every slice plane may be generated and transferred to an additive manufacturing device equipped to process this data during the object manufacturing process. As described earlier, processing of the slice plane data may be done sequentially and in parallel with this process, thus eliminating the large time overhead required when pre-processing this prior to the actual manufacturing process. Additionally, full resolution of the data may be passed to the additive manufacturing device which allows for device and selected material adjustments without loss of precision, accuracy and surface finish that can happen when the data is pre-processed before these factors are known.

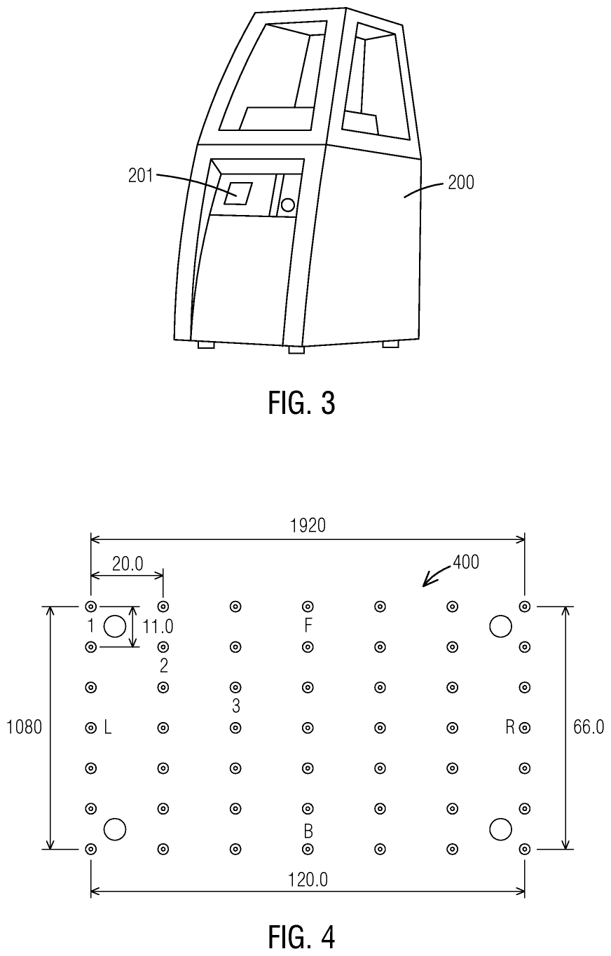

Referring now to FIG. 3, in some aspects, a digital light processing (“DLP”) projector based additive manufacturing device 200 contains memory and computational capability to store and process the set of slice plane data previously generated. The computing system disclosed in FIG. 13 may be a part of the device 200.

In some aspects, each device 200 may internally contain calibration factors to be used during the manufacturing process to correct for small deviations in device 200 hardware which are typical during the manufacture of device 200. Such factors include, but are not limited to, DLP projection system distortion error, DLP projection system keystone error, DLP projection system pixel size error.

By sampling actual output positions in a regular grid pattern, position errors in both x and y direction may be found at each sample point. Modifying the output at these positions is as simple as shifting the position in the opposite direction of the error, the amount of this shift is the “correction.” A grid pattern such as, but not limited to, a rectangular grid pattern may be utilized. In a non-limiting embodiment, for any 4 corners of the rectangular grid pattern, a bi-linear interpolation may be used to calculate a correction for any point within a particular rectangle of the grid pattern. This will precisely correct for any linear error within that rectangular portion of the image. Though localized non-linear errors may not be perfectly corrected, a sufficiently dense grid pattern may be used to minimize correction error caused by non-linear aberrations. Additionally, these non-linear aberrations may also be minimized by utilizing high quality optics within the imaging system of the additive manufacturing device.

FIG. 4 shows an embodiment of a grid pattern for sampling position errors. Though embodiments disclosed herein are not limited to a particular imaging system, or projector, as a non-limiting example, a high-definition formatted projector with a 1920 pixel by 1080 pixel display with a 65-micron pixel size is disclosed. As a non-limiting example, the optical area 400 may be divided into a uniformly spaced 7×7 sampling grid pattern, thus 49 total sampled points. A larger or smaller sampling grid pattern may be used when factoring time required to scan and sample, sampling repeatability, etc. A small margin at the edges of the grid pattern, to allow for 3D printing of the pattern, may be reserved.

Unsampled points on the edge of the optical boundary may be deemed to be the same as the points along the margin. For an HD formatted projector, 36 rectangles may be realized with the same aspect ratio of the projector. Twenty-eight small rectangles surrounding the margins may also be created for a total of 64 areas to be corrected. More sampling points may be added if it is determined to be beneficial as explained later herein in a non-limiting example. As the optical area is enlarged, more sample points may be required to meet a static tolerance requirement.

In operation, to calibrate the additive manufacturing printer, the grid 400 may be printed. The grid 400 may be measured with a contact and non-contact (“CNC”) measurement and inspection system, not shown. A non-limiting representative system is the Quick Vision Active CNC Vision Measuring System provided by Mitutoyo America. This system may produce a file which contains the positions of the sampled points. The file may be processed to identify where corrections in the image are needed.

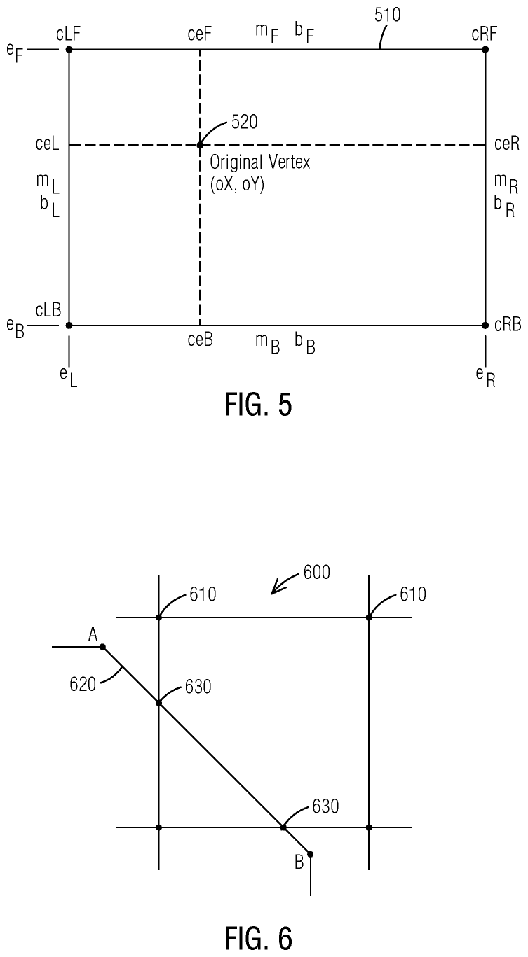

FIG. 5 shows a representation of correction factors being applied to original data. The data with the correction factors may be uploaded to a computing system that is part of at least one of the image system and the printer. Utilizing a process described below, all profile loop vertices are updated by adjusting their XY coordinates based on the correction factors. The grid rectangle 510 containing a vertex 520 is first located and the four correction factors for each corner of that rectangle are loaded.

Because every image is generated from vector “profile loops” it is possible to introduce errors due to unwanted profile self-intersections created by adjusting for nonlinear aberrations. To prevent this, every set of profile loops must ensure a vertex is inserted at every location along a profile edge that is intersected by a grid line before applying corrections.

FIG. 6 shows a close-up view of part of a loop edge on a grid. Correction or sample points 610 are also shown on the grid 600. Where the loop edge 620 intersects the grid 600, new vertices 630 are included where the edge 620 may intersect the grid pattern 600. Then, when the correction factor is applied, the additional vertices assist in eliminating unwanted profile self-intersections.

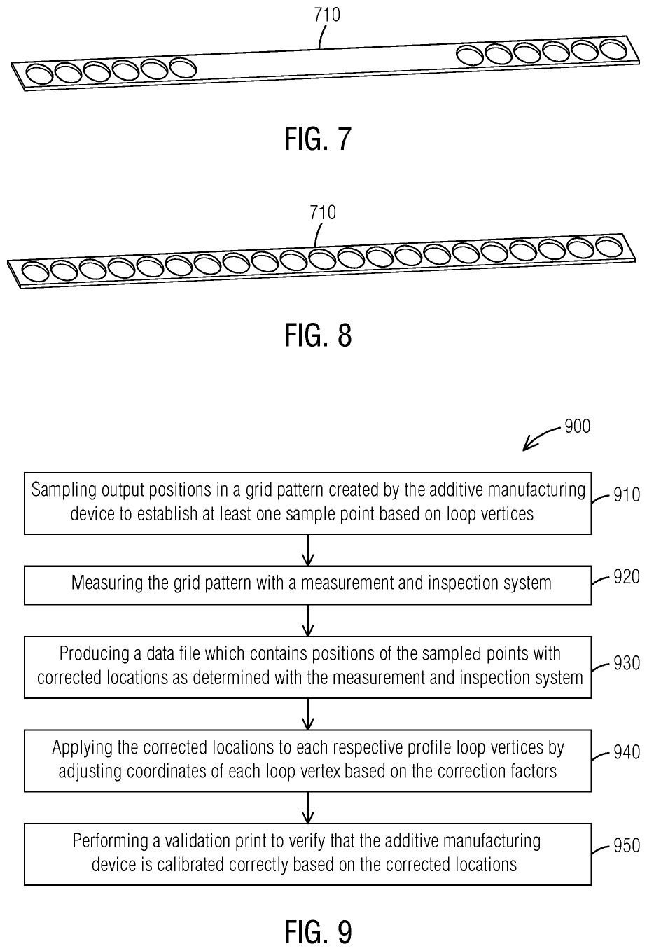

FIG. 7 shows an embodiment of an object of where errors due to unwanted profile self-intersections occurred. Thus, the created object 710 has a section where what was supposed to have been void space is filled, effectively ruining the object 710.

As shown in FIG. 8, the embodiment of the object applied the method discussed with respect to FIG. 6. Thus, the set of profile loops are arranged to ensure self-intersection does not occur. This results in the void space remaining as void space when the object 710 is printed.

The process provides for determining slopes and intercepts for interpolated corrections on each edge. The slopes and intercepts for the interpolated corrections on each edge may be found as follows:

mL=(cLF−cLB)/(eF−eB), bL=cLB−mL*eB

mR=(cRF−cRB)/(eF−eB), bR=cRB−mR*eB

mB=(cRB−cLB)/(eR−eL), bB=cLB−mB*eL

mF=(cRF−cLF)/(eR−eL), bF=cLF−mF*eL

where:
L=Left side (x axis), R=Right side (x axis), L is always less than R
B=Back side (y axis), F=Front side (y axis), B is always less than F
c=Measured correction required in mm, located at the four corners of the rectangle: cLB, cLF, cRB, cRF
e=Edge position, the four edge positions, in mm, of the rectangle: eL, eR, eB, eF
m=Slope of the four edges: mL, mR, mB, mF
b=Intercept of the four edges: bL, bR, bB, bF
   Note that the above calculations may be pre-calculated before processing multiple vertices.

The modified vertex x position and y position may be treated as two separate operations. In each case, a modified correction value may be determined for each edge based on the original vertex x,y, referred to as oX and oY (original X, original Y). For each edge there may be a linearly interpolated correction value, which may be referred to as ceL, ceR, ceB, ceF.

ceR=mR*oY+bR

ceL=mL*oY+bL

ceF=mF*oX+bF

ceB=mB*oX+bB

To find the correction for each x and y value (cX, cY) we use the following formulas:

mX=(ceR−ceL)/(eR−eL), bX=ceL−mX*eL

cX=mX*oX+bX

mY=(ceF−ceB)/(eF−eB), bY=ceB−mY*eB

cY=mY*oY+bY

The new vertex (nX, nY) position is the original plus the bi-linearly interpolated correction.

nX=oX+cX

nY=oY+cY

Next, a validation print is accomplished and measured to ensure the printer is calibrated correctly.

In some aspects, a graphical user interface 201 may allow for dynamic selection of desired material and other factors which further define the material properties, as well as the output object's precision, accuracy, surface finish quality, manufacturing time required and other parameters. These factors may be used by device 200 to optimize the final product output where “to optimize” means to consider the material properties with the embodiments disclosed herein to provide for a more accurate product.

In some aspects, the material used to create the output, or final, product might have associated factors needed to correct for that particular material's unique properties that include, but are not limited to, solidification energy (or “dose”, measured in mJ/cm\hat{ }2), light diffusion, opacity, changes in size and shape during post processing (aka “shrinkage”), etc. The device 200 may utilize these material correction factors to modify the loop data points to correct for known material properties allowing for increased precision and accuracy of the output product.

In some aspects, the corrected slice loop data, for each layer sequentially and in parallel with the additive manufacturing process, may be evaluated. This evaluation may be accomplished by processing the intersection of each pixel against the loop data. The pixel activation level per pixel may be determined by the percentage of the pixel covered by a “solid” loop, minus the percentage of a pixel covered by a void loop. Thus, pixels that are fully void have an activation level of zero percent, pixels that are fully solid have an activation level of 100 percent and “edge” pixels have an activation level between 0 and 100 percent corresponding to the portion of the pixel which is solid. By calculating the activation level as a percentage there is no loss of activation resolution.

In some aspects, the additive manufacturing device may have known variations in illuminated output intensity from pixel to pixel. These output variations are represented as a percentage where 100 percent is the target output and each pixel's known actual output is stored as a percentage of the target output. The activation level per pixel as calculated above is further modified by these known factors. This allows for a pixel-by-pixel activation level adjustment to modify the solidification energy appropriately. For example, if a certain pixel's activation level is calculated to be 93.1% and the solidification energy is 10.0 mJ/cm\hat{ }2, the dose required for this particular pixel is calculated to be 9.31 mJ/cm\hat{ }2.

In some aspects, because the dosage required to solidify pixels for a particular material varies in a non-linear way from the calculated activation level, each material is analyzed and correction factors are determined, which are used to modify the activation levels to correct for this non-linear variable.

In some aspects, the hardware limitation of DLP, LCD, etc., the system's inability to vary individual pixel intensity (mW/cm\hat{ }2) beyond 8-bits of resolution, is overcome by utilizing exposure time (versus the traditional, output intensity variation method, which is limited in resolution to 8-bits on typical systems). For example, if solidification energy required is 10.0 mJ/cm\hat{ }2 and a certain pixel's activation level is 93.1%, the desired pixel dosage is 9.31 mJ/cm\hat{ }2. With the limited 8-bit resolution intensity variation method, the actual dose imparted would be 9.29 mJ/cm\hat{ }2 (0.931*255, rounded to the nearest integer=237. 237/255=0.929) due to 8-bit rounding error. This loss of resolution contributes to errors in accuracy and surface finish quality. Instead, the exposure time variation method holds intensity constant and adjusts the exposure time of each pixel. For example, if the intensity of a given pixel is 1 mW/cm\hat{ }2, and the required dosage for the same pixel is still 9.31 mJ/cm\hat{ }2, then the exposure time required is exactly 9.31 seconds. Given a typical framerate of 60 frames/second, we have 558 levels of “time resolution” which allows for a more accurate dosage for the given pixel.

FIG. 9 shows an embodiment of a flow chart illustrating a method to apply calibration factors determined during an additive manufacturing process to correct for hardware deviations. The method 900 comprises sampling output positions in a grid pattern created by the additive manufacturing device to establish at least one sample point based on loop vertices, at 910. The method 900 further comprises measuring the grid pattern with a measurement and inspection system, at 920. The method also comprises producing a data file which contains positions of the sampled points with corrected locations as determined with the measurement and inspection system, at 930. The method 900 also comprises applying the corrected locations to each respective profile loop vertices by adjusting coordinates of each loop vertex based on the correction factors, at 940. The method 900 further comprises performing a validation print to verify that the additive manufacturing device is calibrated correctly, at 950.

The position error in both x and y direction may be determined at each of the at least one sample point. Furthermore, the method may further comprise determining a correction for any point within a particular part of the grid pattern with bi-linear interpolation.

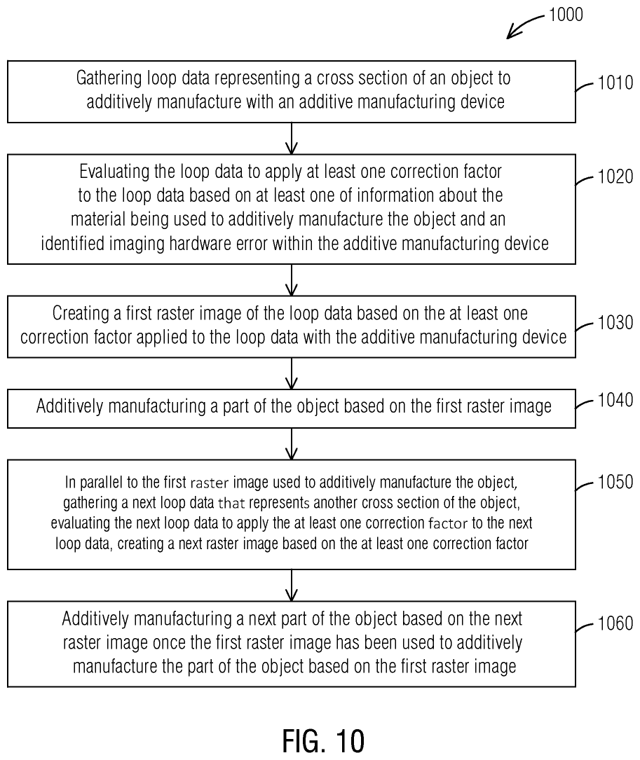

FIG. 10 shows an embodiment of a flowchart illustrating a method which uses of the loops to begin the additive manufacturing process faster than prior art systems and techniques. The method 1000 comprises gathering loop data such as, but not limited to, from a datafile, representing a cross section of an object to additively manufacture with an additive manufacturing device, at 1010. The method 1000 further comprises evaluating the loop data to apply at least one correction factor to the loop data based on at least one of information about the material being used to additively manufacture the object and an identified imaging hardware error within the additive manufacturing device, at 1020. The method 1000 also comprises creating a first raster image of the loop data based on the at least one correction factor applied to the loop data with the additive manufacturing device, at 1030. The method 1000 further comprises additively manufacturing a part of the object based on the first raster image, at 1040.

The method 1000 may further comprise, in parallel to the first raster image used to additively manufacture the object, gathering a next loop data that represents another cross section of the object, evaluating the next loop data to apply the at least one correction factor to the next loop data, creating a next raster image based on the at least one correction factor, at 1050. The method 1000 may further comprise additively manufacturing a next part of the object based on the next raster image once the first raster image has been used to additively manufacture the part of the object based on the first raster image, at 1060. The identified imaging hardware error may comprise determining a hardware deviation in an image system of an additive manufacturing device.

As explained in the Background section and further below, the prior art does not function as this method 1000 teaches since in the prior art the processing of all raster images is done prior to the additive manufacturing printing begins. The embodiments disclosed herein result in the actual printing process to begin faster when compared to the prior art.

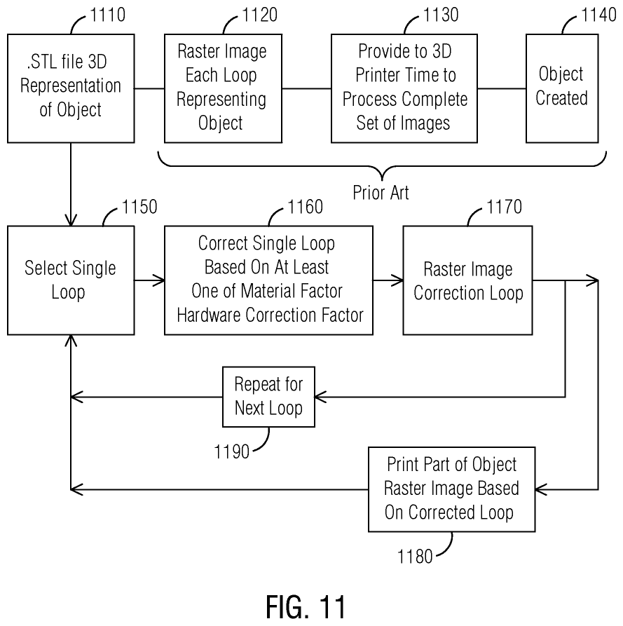

FIG. 11 shows a block diagram representing the process flow of the embodiments disclosed herein compared to the prior art process. As previously discussed, the prior art process starts with a datafile such as, but not limited to, an .stl file, which has a 3D representation of an object that will be created via additive manufacturing, at 1110. Depending on a number of loops (or layers) that will be used to additively manufacture the object, a raster image is created for each loop, at 1120. Depending on the number of loops, a given amount of time is required to create each raster image before the printing process begins. Next, the raster images are provided to the additive manufacturing device, at 1130. Here again, printing is delayed as the additive manufacturing device needs time to process all of the raster images. Once processing is completed, the additive manufacturing device begins the print process, at 1140. Therefore, a user of the additive manufacturing device must wait to know whether the process will even begin as the processing of all of the raster images before printing begins delays in actually seeing or being informed that the printing is occurring.

Using embodiments disclosed herein, a similar delay that is known in the prior art is not realized as the printer 200 begins printing sooner as processing and printing are accomplished in parallel. More specifically, once the three-dimensional (“3D”) representation of the object is provided via the .stl file, at 1110, a first single loop is selected, at 1150. The data in the single loop is corrected based on at least one of information about the material being used to create the object (“material factor”) and a hardware correction factor, as discussed herein, at 1160. A raster image of the single loop, with any corrections applied is then created, at 1170.

The information about the material, or material factor, may be based on optical properties of the material. A non-limiting example may be how light diffuses through the material. Hence, the material factor may also be determined, in part, based on a thickness of the single loop. Other non-limiting examples of material factor may include a type of material, a consistency of the material, and a light dosage needed to produce a certain cure rate or level of the material.

As those skilled in the art recognize, the loop data is lossless data. However, once a raster image is created, some data may be lost. When compared to the prior art approach, the raster images are used to print the object without any correction factor and instead with data loss that may occur across each raster image. By waiting to use loop data that already has at least one correction factor applied, even if data is lost when creating the raster image, the raster image still includes the at least one correction factor which results an improved image over the prior art raster image.

Next, the single raster image is used to create a part of the object at 1180. In parallel with the part being created at 1180, the steps discussed above, 1150, 1160, 1170 are again performed, at 1190. Thus, since a single loop is converted to a single raster image first and then is used to begin the print process, the additive manufacturing device is beginning the print process sooner than the prior art approach. Then, while the actual print process is occurring, the next single loop is being processed for conversion to the next raster image so that printing the next part can begin as soon as the additive manufacturing printer is available (once the prior or first part has been printed).

A data file from which loop data may be retrieved is an .stl file. The .stl file defines the mesh of points which defines the surface of the object to be created. Each individual loop represents a cross section of the object to additively manufacture with an additive manufacturing device. The user may create or acquire the .stl file with sufficient datapoints to accurately model the object.

Utilizing a mesh approach with loops and maintaining the data in .stl files results in a lossless dataset being stored. The mesh must be a closed loop so that the mesh may be defined. Whereas the prior art approach of rastering an image results in data that is not complete as data losses are realized resulting in loss of fidelity of the image. Furthermore, rastering takes time and is just an approximation of the slice to be constructed. More specifically, a rastered image is not an exact image as rastered losses are realized resulting in a loss of fidelity of the original image.

In the embodiments disclosed herein, both application of loops and rastering may be done in parallel to accelerate the printing process where the .stl file is used to minimize losses realized from rastering the object.

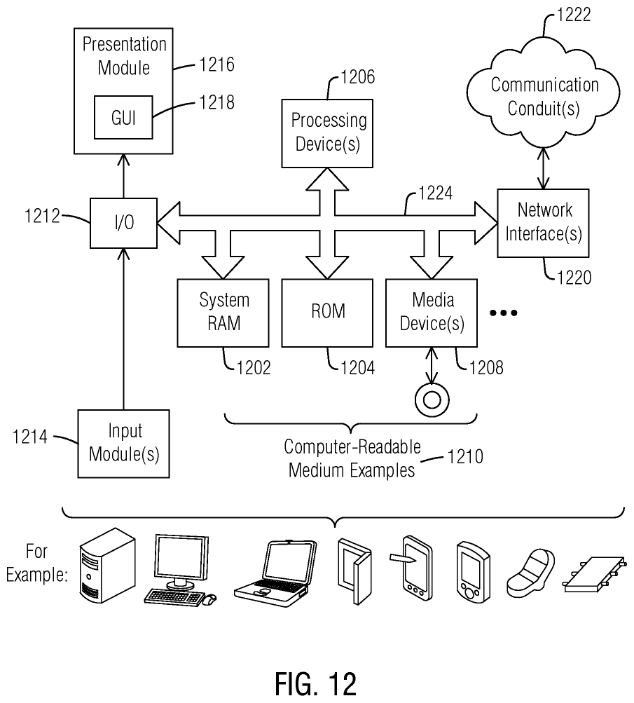

Referring now to FIG. 12, a block diagram of an exemplary computer system, or computing functionality, 1200 useful for implementing various aspects the processes disclosed herein, in accordance with one or more aspects of the present disclosure, is shown. In a basic configuration, a computing device 1200 may include any type of stationary computing device or a mobile computing device. The computing device may be part of the additive manufacturing device as disclosed above. The computing device may include one or more processors 1206 and system memory 1210 in a hard drive, or media device, 1208. Depending on the exact configuration and type of computing device, system memory 1210 may be volatile (such as RAM), non-volatile (such as read only memory (ROM), flash memory, and the like) or some combination of the two. A system memory 1210 may store an operating system, one or more applications, and may include program data for performing flight, navigation, avionics, power managements operations such as for space operations.

The computing device 1200 may carry out one or more blocks of a process and or the additive manufacturing processes described herein. The computing device may also have additional features or functionality. As a non-limiting example, the computing device may also include additional data storage devices (removable and/or non-removable) such as, for example, magnetic disks, optical disks, or tape. The computer storage media may include volatile and non-volatile, non-transitory, removable and non-removable media implemented in any method or technology for storage of data, such as computer readable instructions, data structures, program modules or other data. The system memory, removable storage and non-removable storage are all non-limiting examples of computer storage media. The computer storage media may include, but is not limited to, RAM, ROM, Electrically Erasable Read-Only Memory (EEPROM), flash memory or other memory technology, compact-disc-read-only memory (CD-ROM), digital versatile disks (DVD) or other optical storage, magnetic cassettes, magnetic tape, magnetic disk storage or other magnetic storage devices, or any other physical medium which can be used to store the desired data, and which can be accessed by computing device. Any such computer storage media may be part of device.

The computing device may also include or have interfaces 1212 for input device(s) 1214 (not shown) such as a keyboard, mouse, pen, voice input device, touch input device, etc. The computing device 1200 may include or have interfaces for connection to output device(s) such as a display, speakers, etc. The computing device may include a peripheral bus for connecting to peripherals. The computing device 1200 may also connect to a presentation module 1216 and a graphical user interface 1218. Computing device 1200 may contain communication connection(s) 1222 that allow the device to communicate with other computing devices, such as over a network or a wireless network via a network interface 1220. By way of example, and not limitation, communication connection(s) may include wired media such as a wired network or direct-wired connection, and wireless media such as acoustic, radio frequency (RF), infrared and other wireless media. The computing device may include a network interface card to connect (wired or wireless) to a network.

Computer program code for carrying out operations described above may be written in a variety of programming languages, including but not limited to a high-level programming language, such as C or C++, for development convenience. In addition, computer program code for carrying out operations of embodiments described herein may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed Digital Signal Processor (DSP) or microcontroller. A code in which a program of the embodiments is described can be included as a firmware in a RAM, a ROM and a flash memory. Otherwise, the code can be stored in a tangible computer-readable storage medium such as a magnetic tape, a flexible disc, a hard disc, a compact disc, a photo-magnetic disc, a digital versatile disc (DVD).

The embodiments may be configured for use in a computer or a data processing apparatus which includes a memory, such as a central processing unit (CPU), a RAM and a ROM as well as a storage medium such as a hard disc.

The “step-by-step process” for performing the claimed functions herein is a specific algorithm, and may be shown as a mathematical formula, in the text of the specification as prose, and/or in a flow chart. The instructions of the software program create a special purpose machine for carrying out the particular algorithm. Thus, in any means-plus-function claim herein in which the disclosed structure is a computer, or microprocessor, programmed to carry out an algorithm, the disclosed structure is not the general-purpose computer, but rather the special purpose computer programmed to perform the disclosed algorithm.

A general-purpose computer, or microprocessor, may be programmed to carry out the algorithm/steps for creating a new machine. The general-purpose computer becomes a special purpose computer once it is programmed to perform particular functions pursuant to instructions from program software of the embodiments described herein. The instructions of the software program that carry out the algorithm/steps electrically change the general-purpose computer by creating electrical paths within the device. These electrical paths create a special purpose machine for carrying out the particular algorithm/steps.

Unless otherwise defined, all terms (including technical and scientific terms) used herein have the same meaning as commonly understood by one of ordinary skill in the art to which embodiments belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In particular, unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such data storage, transmission or display devices.

The terminology used herein is for the purpose of describing particular embodiments only and is not intended to be limiting. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.” Moreover, unless specifically stated, any use of the terms first, second, etc., does not denote any order or importance, but rather the terms first, second, etc., are used to distinguish one element from another. As used herein the expression “at least one of A and B,” will be understood to mean only A, only B, or both A and B.

Aspects of the present disclosure meet the above-identified needs by providing systems, methods, and computer program products which facilitate the timely evaluation of three-dimensional object data into additive manufacturing device formats which allow for enhanced accuracy via modification of data based on device calibration and specific selected output material factors. Specifically, in an aspect, systems, methods, and computer program products are disclosed wherein the additive manufacturing device assumes a portion of the evaluation process and distributes the required computational time in parallel with the actual manufacturing process as well as increasing activation resolution beyond the 8-bit limits of typical pixel devices by utilizing a time-based dosage method which provides enhanced resolution in excess of current 8-bit intensity methods.

In an aspect, the computational device will produce an output suitable for an additive manufacturing device by representing each layered pattern as a collection of “loops”. These loops are formed by evaluating the intersection of a plane, created at the selected layer's elevation, and the “mesh” of polygon data that represents the object to be created. This intersection results in multiple connected line segments that are share common vertices, forming complete loops. Loops representing solid areas of the object are denoted differently from the loops representing void areas. Collectively, this collection of layers, containing all solid and void loops for each layer, accurately represent the object data without the precision and accuracy loss experienced with current methods. Additionally, since the data is not converted to pixel activation levels during this process, the processing time required is greatly reduced.

Thus, the loops may be used in a method by representing each layered pattern of an object to be additive manufactured as a collection of loops which are formed by evaluating an intersection of a plane, created at a selected layer's elevation, and a mesh of polygon data that represents the object to be created to provide information for use by an additive manufacturing device to create the object. The method may also comprise providing the collection of loops to the additive manufacturing device. The method may further comprise determining the collection of loops in parallel with a rastered image of each layered pattern to accelerate an additive manufacturing process of the additive manufacturing. The method finally comprises producing the object based on the collection of loops.

In some aspects, the additive manufacturing device might have associated calibration factors that correct for errors inherent in its assembly. For example, DLP based projection systems might have some degree of scaling, keystone and or distortion errors. After assembly, correction factors may be calculated for the individual device. The disclosed method can use these correction factors to modify the loop data points to correct for the hardware errors and allowing for increased precision and accuracy of the output product.

In some aspects, because the dosage required to solidify pixels for a particular material varies in a non-linear way from the calculated activation level, each material is analyzed and correction factors are determined, which are used to modify the activation levels to correct for this non-linear variable.

In some aspects, the limitation of DLP, LCD, etc., systems, such as the inability to vary individual pixel intensity (mW/cm\hat{ }2) beyond 8-bits of resolution, is overcome by utilizing exposure time.

While various disclosed embodiments have been described above, it should be understood that they have been presented by way of example only, and not limitation. Numerous changes, omissions and/or additions to the subject matter disclosed herein can be made in accordance with the embodiments disclosed herein without departing from the spirit or scope of the embodiments. Also, equivalents may be substituted for elements thereof without departing from the spirit and scope of the embodiments. In addition, while a particular feature may have been disclosed with respect to only one of several implementations, such feature may be combined with one or more other features of the other implementations as may be desired and advantageous for any given or particular application. Furthermore, many modifications may be made to adapt a particular situation or material to the teachings of the embodiments without departing from the scope thereof.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present disclosure in any way.

Therefore, the breadth and scope of the subject matter provided herein should not be limited by any of the above explicitly described embodiments. Rather, the scope of the embodiments should be defined in accordance with the following claims and their equivalents.

1. A method to calibrate factors to correct at least one hardware deviation in an image system of an additive manufacturing device, the method comprising:
sampling output positions in a grid pattern created by the additive manufacturing device to establish at least one sample point based on loop vertices;
measuring the grid pattern with a measurement and inspection system;
producing a data file which contains positions of the sampled points with corrected locations as determined with the measurement and inspection system;
applying the corrected locations to each respective profile loop vertices by adjusting coordinates of each loop vertex based on the correction factors; and
performing a validation print to verify that the additive manufacturing device is calibrated correctly based on the corrected locations.

2. The method according to claim 1, wherein a position error in both x and y direction is determined at each of the at least one sample point.

3. The method according to claim 1, further comprising determining a correction for any point within a particular part of the grid pattern with bi-linear interpolation.

4. The method according to claim 1, further comprising storing corrected locations for application during a later use of the additive manufacturing device.

5. A non-transitory processor readable storage medium residing on a mobile device, providing an executable computer program product, the executable computer program product comprising a computer software code that, when executed on a processor, causes the processor to:
sample output positions in a grid pattern created by the additive manufacturing device to establish at least one sample point based on loop vertices;
measure the grid pattern with a measurement and inspection system;
produce a data file which contains positions of the sampled points with corrected locations as determined with the measurement and inspection system;
apply the corrected locations to each respective profile loop vertices by adjusting coordinates of each loop vertex based on the correction factors; and
perform a validation print to verify that the additive manufacturing device is calibrated correctly.

6. The non-transitory processor readable storage medium according to claim 5, further causing the processor to determine a correction for any point within a particular part of the grid pattern with bi-linear interpolation.

7. The non-transitory processor readable storage medium according to claim 5, further causing the processor to store the corrected locations for application during a later use of the additive manufacturing device.

8. A system, the system comprising:
a processor utilizing a non-transitory processor readable storage medium to sample output positions in a grid pattern created by the additive manufacturing device to establish at least one sample point based on loop vertices;
the processor utilizing the non-transitory processor readable storage medium to measure the grid pattern with a measurement and inspection system;
the processor utilizing the non-transitory processor readable storage medium to produce a data file which contains positions of the sampled points with corrected locations as determined with the measurement and inspection system;
the processor utilizing the non-transitory processor readable storage medium to apply the corrected locations to each respective profile loop vertices by adjusting coordinates of each loop vertex based on the correction factors;
an additive manufacturing device to create a validation print; and
the processor utilizing the non-transitory processor readable storage medium to verify that the additive manufacturing device is calibrated correctly based on the validation print.

9. The system according to claim 8, wherein a position error in both x and y direction is determined at each of the at least one sample point.

10. The system according to claim 8, further comprising the processor utilizing the non-transitory processor readable storage medium to determine a correction for any point within a particular part of the grid pattern with bi-linear interpolation.

11. The system according to claim 8, further comprising the processor utilizing the non-transitory processor readable storage medium to store corrected locations for application during a later use of the additive manufacturing device.

12. The system according to claim 8, further comprising the measurement and inspection system.
